(19) United States
(12) Patent Application Publication
(10) Pub. No.: US 2025/0255436 A1
(43) Pub. Date: Aug. 14, 2025

(54) POWER TAKE OFF MASHING ATTACHMENT FOR A STAND MIXER APPLIANCE

(71) Applicant: Haier US Appliance Solutions, Inc., Wilmington, DE (US)

(72) Inventors: Megan Hunter, Louisville, KY (US); Katie Beachler, Jeffersonville, IN (US); Emily Rose Ashburn, Louisville, KY (US)

(21) Appl. No.: 18/436,764

(22) Filed: Feb. 8, 2024

(51) Int. Cl. A47J 43/07; A47J 43/044

(52) U.S. Cl. CPC A47J 43/0711; A47J 43/044; A47J 2043/04454

(57) ABSTRACT

A stand mixer includes a housing and a motor disposed in the housing. The stand mixer also includes a power take off at the housing and a masher attachment coupled to the power take off of the housing. The masher attachment includes a transmission mechanically coupled to the power take off and a masher drum coupled to the transmission. The masher drum is configured for receipt of food items for mashing.

### FIELD OF THE INVENTION

The present subject matter relates generally to stand mixer appliances, and specifically to systems for mashing food items with the stand mixer appliance.

### BACKGROUND OF THE INVENTION

Stand mixers are generally used for performing mixing, churning, or kneading involved in food preparation. Typically, stand mixers include a motor configured to provide torque to one or more driveshafts. Users may connect various utensils to the one or more driveshafts, including whisks, spatulas, or the like. When performing food preparation on potatoes, which have a large amount of starch, the cells that contain the starch burst and release a tacky gel that binds into mashed potatoes. When overcooking or over mashing the potatoes, the tacky gel may result in very gummy, sticky mashed potatoes due to too much starch bursting from the cells. Traditionally, chefs and/or professional cooks prefer using manual methods along with separate appliances such as a ricer or a food mill to achieve smooth and fluffy mashed potatoes. However, for the typical user, to achieve smooth and fluffy mashed potatoes, handheld manual tools may be used. The use of handheld tools is typically a manually intensive process and is undesirable to users due to it being manually intensive.

Accordingly, a stand mixer with a masher attachment for automatically mashing potatoes and avoiding over mashing the potatoes would be advantageous in the art.

### BRIEF DESCRIPTION OF THE INVENTION

Aspects and advantages of the invention will be set forth in part in the following description, or may be apparent from the description, or may be learned through practice of the invention.

In one example embodiment, a stand mixer is provided. The stand mixer defines a vertical direction, a lateral direction, and a transverse direction. The vertical, lateral, and transverse directions are mutually perpendicular. The stand mixer includes a housing and a motor disposed in the housing. The stand mixer also includes a mixing shaft operably coupled to the motor and a power take off at the housing. A masher attachment is coupled to the power take off of the housing. The masher attachment includes a transmission mechanically coupled to the power take off and a masher drum coupled to the transmission. The masher drum is configured for receipt of food items for mashing. A funnel is coupled to a bottom side of the masher drum.

In another example embodiment, a stand mixer is provided. The stand mixer includes a housing and a motor disposed in the housing. The stand mixer also includes a power take off at the housing and a masher attachment coupled to the power take off of the housing. The masher attachment includes a transmission mechanically coupled to the power take off and a masher drum coupled to the transmission. The masher drum is configured for receipt of food items for mashing.

In another example embodiment, a masher attachment for a stand mixer is provided. The masher attachment includes a transmission mechanically coupled to a power take off of the stand mixer, and a masher drum coupled to the transmission of the masher attachment. The masher drum is configured for receipt of food items for mashing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side view of an example stand mixer with a bowl according to example embodiments of the present disclosure.

FIG. 2 provides a side view of the stand mixer with a mixing attachment according to example embodiments of the present disclosure.

FIG. 3 illustrates a side view an example embodiment of a masher attachment attached to the stand mixer of FIG. 1, in accordance with aspects of the present disclosure.

FIG. 4 illustrates a side, section view of the example embodiment of the masher attachment of FIG. 3 in accordance with aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related.

The terms “coupled,” “fixed,” “attached to,” and the like refer to both direct coupling, fixing, or attaching, as well as indirect coupling, fixing, or attaching through one or more intermediate components or features, unless otherwise specified herein.

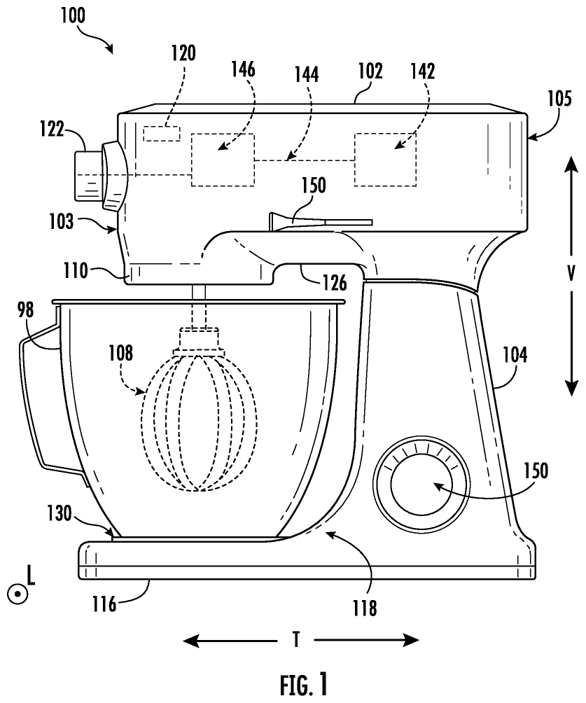

The present disclosure provides a mixer appliance with a secure mixing attachment coupling to a mixing shaft of the mixer appliance. This secure coupling may allow the mixer to rotate the shaft with the secured mixing attachment in clockwise and counterclockwise motions. The figures depict an example stand mixer appliance 100 that may be configured in accordance with various aspects of the present disclosure. It should be appreciated that the invention is not limited to any particular style, size, model, or shape for stand mixer appliance 100. The example embodiment in FIG. 1 is for illustrative purposes only. For example, appliance 100 may have different shapes and appearance for one or more parts, different motor and gear configurations, and other differences while remaining within the scope of the claimed subject matter.

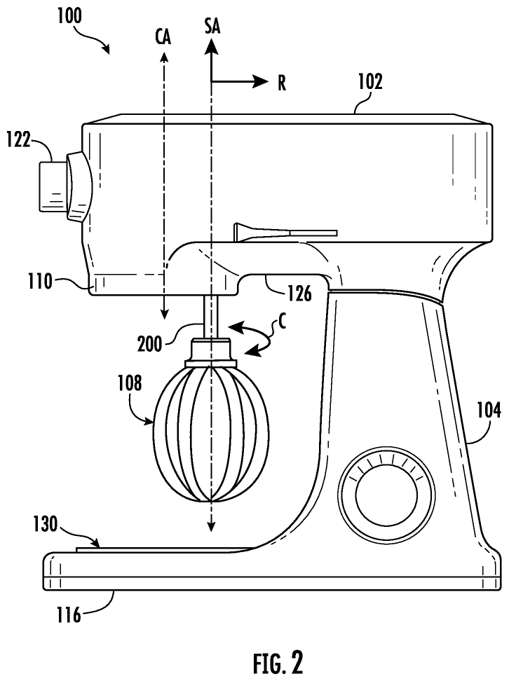

With reference for FIGS. 1 and 2, for the particular embodiment shown, a stand mixer appliance 100 includes a housing 102 and a base 104. Stand mixer 100 may extend between housing 102 and base 104 in a vertical direction V, across housing 102 in a lateral direction L, and from a front 103 to a back 105 in a transverse direction T. The vertical direction V, lateral direction L, and transverse direction T are perpendicular to one another.

Housing 102 may be pivotally mounted to base 104 and extends transversely between front 103 and back 105 of stand mixer appliance 100 when in the mixing position shown in FIG. 1. In some embodiments, housing 102 may be non-pivotably attached to base 104. Other configurations may be used where housing 102 may allow for access to a bowl 98 or to a removable mixing attachment 108, as otherwise understood. For this embodiment, base 104 includes upright support 112 and a horizontal base member 116. As shown, upright support 112 extends vertically from horizontal base member 116 and horizontal base member 116 extends transversely in front of upright support 112. Horizontal base member 116 may include a scale 130. In some embodiments, scale 130 may be concave, grooved, or otherwise shaped to accept bowl 98. Scale 130 may be generally configured to weigh bowl 98 and the contents therein.

Housing 102 includes an attachment support 110. A motor 142 is disposed within the housing 102. Attachment support 110 is located on a lower portion or underside 126 of housing 102 and forward of upright support 112 along transverse direction T. A mixing shaft 200 extends from attachment support 110. Removable mixing attachment 108 removably attaches to shaft 200.

Drivetrain 144 connects motor 142 with one or more gears 146 for causing rotation of attachment 108 or mixing shaft 200, e.g., mixing shaft 200 may be operably coupled to motor 142. Gears 146 may allow for selection by the user of different rotating speeds for attachment 108. In general, mixing attachment 108 may be coupled to shaft 200 prior to rotation of shaft 200 by motor 142. Furthermore, a power take off 122 may be positioned at housing 102, e.g., power take off 122 may extend from front 103 of housing 102. In general, power take off 122 may be mechanically coupled to drivetrain 144, ergo motor 142.

Stand mixer 100 may include one or more controls 150 for operations such as selectively powering motor 142, choosing the speed of rotation for attachments 108, locking position of housing 102 relative to base 104 during mixing, or other features. In some embodiments, controls 150 may include a rotational direction operation selection, allowing a user to select the direction of rotation of the mixing shaft 200.

In certain embodiments, attachment support 110 may accept more than one attachment 108. Various types of attachments 108 may be used including e.g., whisks, paddles, dough hooks, beaters, and others for purposes of mixing articles or mechanically manipulating articles within bowl 98 or other containers supported by base 104. During use, attachment support 110 with mixing shaft 200 may rotate attachment 108 in a circular or planetary fashion. Spinning in a planetary fashion, as used herein, includes spinning an object (e.g., shaft 200) about a first axis and revolving the object around a second axis, the object offset from the second axis. For example, shaft 200 may spin about a shaft axis SA, and revolve around a central axis CA, shaft 200 offset from central axis CA to generate spinning in a planetary rotation. Shaft axis SA may also be offset from central axis CA. In some embodiments, motor 142 may be disposed within base 104, including within upright support 112.

As shown in FIG. 2, mixing shaft 200 may rotate within attachment support 110. Mixing attachment 108 and mixing shaft 200 are rotatable by motor 142 in planetary rotation. Mixing shaft may define the shaft axis SA, with a radial direction R extending therefrom perpendicular to the shaft axis SA, and a circumferential direction C extending around the central axis CA. Mixing shaft 200 may rotate around central axis CA, wherein mixing shaft 200 is rotating in circumferential direction C. Additionally or alternatively, motor 142 may be operable to selectively rotate mixing attachment 108 in a clockwise direction or a counterclockwise direction in circumferential direction C around shaft axis SA. Thus, mixing shaft 200 may be reversible, or moveable in either direction during use. Attachment of mixing attachment 108 to shaft 200 allows for motion in both directions, clockwise and counterclockwise, by motor 142. In other words, motor 142 can rotate mixing attachment 108 and/or shaft 200 in a clockwise direction and can switch and rotate mixing attachment 108 and/or shaft 200 in a counterclockwise direction. Such movement may be directed by a user (e.g., by use of controls 150) or may be directed independent of a user, e.g., by using a timer, by using a controller, described hereinbelow, in operable communication with motor 142, or as otherwise understood.

In general, stand mixer 100 may include a controller 120. In particular, controller 120 may be located within housing 102. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 142). For instance, controller 120 may include a printed circuit board (PCB) with various components coupled thereto, as would be understood by those of ordinary skill in the art.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, controls 150 may include one or more microprocessors and/or one or more memory devices. Accordingly, certain components of stand mixer 100 may be controlled directly from controls 150. For example, controller 120 may be generally configured to perform a mixing cycle, whereby stand mixer 100 may be operated to mix food contents, such as food contents in bowl 98.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

As one skilled in the art will appreciate, the above described embodiments are used only for the purpose of explanation. Modifications and variations may be applied, other configurations may be used, and the resulting configurations may remain within the scope of the invention. For example, stand mixer 100 is provided by way of example only and aspects of the present subject matter may be incorporated into any other suitable stand mixer appliance.

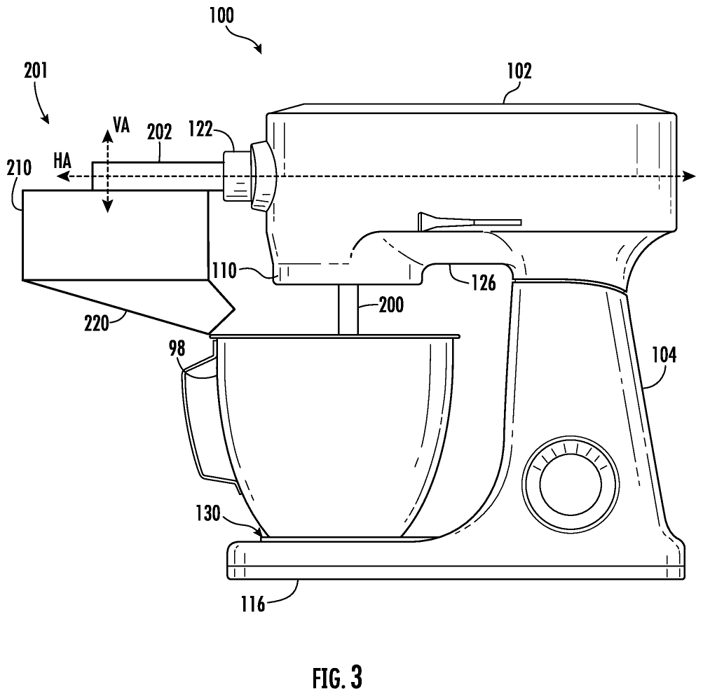

Turning now to FIG. 3, illustrated is an example embodiment of a masher attachment 201 attached to stand mixer 100. In general, masher attachment 201 may be coupled to power take off 122 of housing 102. More specifically, masher attachment 201 may include a transmission 202 mechanically coupling the masher attachment 201 to power take off 122, ergo motor 142. In particular, power take off 122, e.g., motor 142, may provide mechanical motion about a horizontal axis HA, and transmission 202 may be any suitable gear train or drive train configured to convert the horizontal motion to vertical motion about a vertical axis VA. Such a transmission would be understood by one of skill in the art. In some example embodiments, transmission 202 may be omitted or replaced with other suitable components.

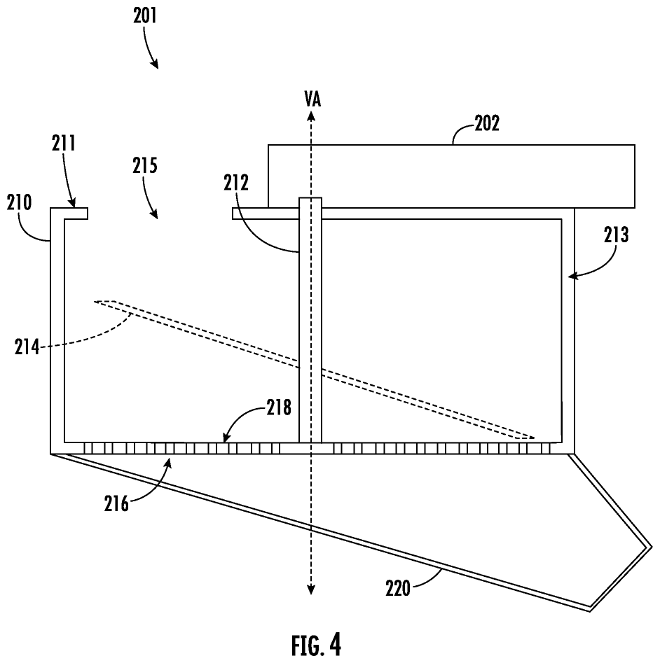

In general, transmission 202 may be coupled to a masher drum 210 of the masher attachment 201. In certain example embodiments where transmission 202 is omitted, masher drum 210 may be directly coupled to power take off 122. Masher drum 210 may generally be a circular drum, e.g., defined within a top side 211, a circular sidewall 213, and a bottom side 218, configured for receiving food items for mashing. Additionally, some example embodiments may include a funnel 220 coupled to bottom side 218 of masher drum 210, e.g., funnel 220 may be configured to direct, via gravity, mashed food product to bowl 98. For example, referring now to FIG. 4, an opening 215 may be defined in top side 211 of masher drum 210. Opening 215 may generally be sized proportionally to accept whole food items, such as whole potatoes.

In particular, FIG. 4 illustrates a side, section view masher attachment 201. As may be seen, transmission 202 may be coupled to a shaft 212 extending along the vertical axis VA within masher drum 210. Further, masher drum 210 may include a masher disk 214 coupled to shaft 212, generally configured to rotate within masher drum 210. Masher disk 214 may generally be angular or angled such that rotation of masher disk 214 in one direction results in, at least partial, downward force. For example, masher drum 210 may include a plurality of holes 216 extending through bottom side 218 of masher drum 210, whereby, when masher disk 214 rotates within masher drum 210, food items within masher drum 210 are forced/influenced by masher disk 214 downwards through the plurality of holes 216. As such, bowl 98 may be positioned beneath masher attachment 201, or, more specifically, funnel 220 of the masher attachment 201 may be configured to, with the aid of gravity, direct mashed food product to bowl 98. Accordingly, in the present example embodiment, bowl 98 of stand mixer 100 is a main mixing bowl 98, e.g., positioned beneath mixing shaft 200 in the vertical direction V. It should be appreciated that a secondary, accessory style bowl may be attached to masher drum 210 and used in place of funnel 220 and bowl 98, however, in the present example embodiment bowl 98 is the main mixing bowl of stand mixer 100.

As may be seen from the above, a stand mixer may include a potato mashing attachment coupled to the stand mixer using an attachment port. The attachment may include a rotating feature to smash the potatoes through a mesh. Further, a funnel provided on the attachment may guide the mashed product into a mixing bowl of the stand mixer. Accordingly, the mashing attachment may advantageously automatically mash food items, such as potatoes, and aid producing creamy mashed potatoes with less stickiness and manual labor than other methods.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer defining a vertical direction, a lateral direction, and a transverse direction, the vertical, lateral, and transverse directions being mutually perpendicular, the stand mixer comprising:
a housing;
a motor disposed in the housing;
a mixing shaft operably coupled to the motor;
a power take off at the housing; and
a masher attachment coupled to the power take off of the housing, the masher attachment comprising:
a transmission mechanically coupled to the power take off;
a masher drum coupled to the transmission, the masher drum configured for receipt of food items for mashing; and
a funnel coupled to a bottom side of the masher drum.

2. The stand mixer of claim 1, wherein the masher drum of the masher attachment comprises a masher disk configured to rotate within the masher drum.

3. The stand mixer of claim 1, wherein the masher drum of the masher attachment comprises a plurality of holes extending through the bottom side of the masher drum.

4. The stand mixer of claim 1, further comprising a bowl positioned beneath the masher attachment, wherein the funnel of the masher attachment is configured to direct mashed food product to the bowl.

5. The stand mixer of claim 4, wherein the bowl of the stand mixer is a main mixing bowl positioned beneath the mixing shaft in the vertical direction.

6. The stand mixer of claim 1, further comprising an opening defined through a top side of the masher drum, the opening configured for receipt of food items for mashing.

7. A stand mixer, comprising:
a housing;
a motor disposed in the housing;
a power take off at the housing; and
a masher attachment coupled to the power take off of the housing, the masher attachment comprising:
a transmission mechanically coupled to the power take off; and
a masher drum coupled to the transmission, the masher drum configured for receipt of food items for mashing.

8. The stand mixer of claim 7, wherein the masher drum of the masher attachment comprises a masher disk configured to rotate within the masher drum.

9. The stand mixer of claim 7, wherein the masher drum of the masher attachment comprises a plurality of holes extending through a bottom side of the masher drum.

10. The stand mixer of claim 9, further comprising a funnel coupled to the bottom side of the masher drum.

11. The stand mixer of claim 10, further comprising a bowl positioned beneath the masher attachment, wherein the funnel of the masher attachment is configured to direct mashed food product to the bowl.

12. The stand mixer of claim 7, further comprising an opening defined through a top side of the masher drum, the opening configured for receipt of food items for mashing.

13. A masher attachment for a stand mixer, the masher attachment comprising:
a transmission mechanically coupled to a power take off of the stand mixer; and
a masher drum coupled to the transmission of the masher attachment, the masher drum configured for receipt of food items for mashing.

14. The masher attachment of claim 13, wherein the masher drum of the masher attachment comprises a masher disk configured to rotate within the masher drum.

15. The masher attachment of claim 13, wherein the masher drum of the masher attachment comprises a plurality of holes extending through a bottom side of the masher drum.

16. The masher attachment of claim 15, further comprising a funnel coupled to the bottom side of the masher drum.

17. The masher attachment of claim 16, further comprising a bowl positioned beneath the masher attachment, wherein the funnel of the masher attachment is configured to direct mashed food product to the bowl.

18. The masher attachment of claim 13, further comprising an opening defined through a top side of the masher drum, the opening configured for receipt of food items for mashing.
